(19) United States
(12) Patent Application Publication
(10) Pub. No.: US 2026/0187417 A1
(43) Pub. Date: Jul. 2, 2026

(54) TECHNIQUES FOR STANDARDIZED INTERACTION CLASSIFICATION ACROSS MULTIPLE COMMUNICATION CHANNELS USING A MACHINE-LEARNED ARCHITECTURE

(71) Applicant: OPTUM, INC., Minnetonka, MN (US)

(72) Inventors: Rahul Aggarwal, Karnataka (IN); Ankit Kindra, Delhi (IN); Aditya Teja Josyula, Collierville, TN (US); Muskan, Haryana (IN); Kartik Krishna Bhardwaj, Haryana (IN); Syed Salman Abbas Baqri, Uttar Pradesh (IN); Lubna Khan, Centerville, GA (US)

(73) Assignee: OPTUM, INC., Minnetonka, MN (US)

(21) Appl. No.: 19/006,924

(22) Filed: Dec. 31, 2024

(51) Int. Cl. G06N 3/0455

(52) U.S. Cl. CPC G06N 3/0455

(57) ABSTRACT

Techniques for standardized interaction classification across multiple communication channels may comprise receiving interaction data associated with a user interaction with a device associated with a communication channel and generating an interaction summary of the user interaction. The techniques may further comprise generating a feature vector of the interaction summary and determining semantic similarity values of the interaction summary feature vector and one or more feature vectors representing interaction description taxonomies of a standardized interaction classification schema. The techniques may further comprise determining an interaction label of the schema that corresponds to the interaction summary and generating a data object that indicates the interaction label. These techniques generate accurate, generalizable interaction labels without performing significantly redundant computing processes and/or otherwise occupying substantial computing resources.

### TECHNICAL FIELD

The present disclosure generally relates to a machine learning architecture for classifying digital signals and data structures indicating one or more user interactions with a computing device and/or network. The architecture is structured and trained to classify user interactions across multiple different communication channels and for different classification taxonomies.

### BACKGROUND

Techniques for determining user intent based on data from user interactions suffer from notable drawbacks. Namely, conventional techniques are generally incapable of evaluating similar user intents across different communication channels (due in part to different communication channels including different types of sensors and/or data generated thereby), require prohibitive amounts of training data, and/or are unable to account for new/nuanced user intents described during complex interactions. Existing techniques may require extensive labelled datasets for model training and retraining/updating for each new/nuanced user intent, communication channel, or changes in classification taxonomy, which consumes significant processing resources for largely redundant training processes. Other existing techniques may be inaccurate, especially when encountering new/nuanced user intents, as the models may output hallucinations that are incorrect or irrelevant. In either case, such existing models are typically configured to evaluate interactions occurring on a single communication channel, resulting in substantial duplication of effort to develop/implement models for each unique communication channel.

### BRIEF DESCRIPTION OF THE DRAWINGS

The figures described below depict embodiments for purposes of illustration only. One skilled in the art will readily recognize from the following discussion that alternative embodiments of the systems and methods illustrated herein may be employed without departing from the principles of the disclosure described herein. The detailed description is described with reference to the accompanying figures. In the figures, the same reference number appearing in different figures indicates a same or similar item.

FIG. 1 depicts an example computing system in which various embodiments of the present disclosure may be implemented.

FIG. 2 depicts an example interaction classification computer-implemented process, in accordance with various embodiments described herein.

FIG. 3 depicts an example standardized interaction classification schema creation computer-implemented process, in accordance with various embodiments described herein.

FIG. 4 depicts an example interaction summary generation computer-implemented process across different communication channels, in accordance with various embodiments described herein.

FIG. 5 depicts an example interaction summary classification computer-implemented process using a standardized interaction classification schema, in accordance with various embodiments described herein.

FIG. 6 depicts a flow diagram representing an example computer-implemented method, in accordance with various embodiments described herein.

### DETAILED DESCRIPTION

Broadly speaking, the user interaction classification techniques of the present disclosure accurately determine interaction labels that correspond to summaries of interactions involving a user across a communication channel. More specifically, the techniques of the present disclosure may leverage generative machine-learned model(s) (e.g., transformer-based machine-learned model(s), large language model(s) (LLM(s)) and encoders to generate interaction summaries of user interactions with devices associated with one or more communication channels and feature vectors of such interaction summaries, regardless of the number or type of communication channels. The techniques of the present disclosure may then determine semantic similarities between an interaction summary feature vector and interaction description taxonomy feature vectors and an interaction label corresponding to the interaction description taxonomy feature vector that is most semantically similar to the interaction summary feature vector and/or data objects indicating the same. The techniques of the present disclosure improve upon conventional user interaction classification techniques at least by generating more accurate outputs than such conventional techniques, outputs that may be tailored to a particular system and that dynamically updates outputs based on changes to the system without retraining or fine-tuning a model or without significant fine-tuning, and by determining outputs, regardless of the communication channel(s) used by a user.

As referenced herein, a “user interaction” may reference data (e.g., interaction data) that results from a user interacting with a device that may be associated with a communication channel (e.g., phone call, website, text chat, interactive voice response (IVR) system, email, social media). More specifically, the user interaction may include sensor data (e.g., image data, audio data, motion data) and/or input data (e.g., text associated with keystrokes during a chat session, voice commands, mouse movements/clicks, touch sensor data). For example, a first user interaction may include data resulting from the user calling and speaking with a human agent on the phone (e.g., audio data). A second user interaction may include data resulting from the user visiting a website, such as clickstream data associated with actions performed by the user in association with the website (e.g., clicking links, buttons, and/or images on the website, page views, mouse movements, search queries, session duration).

Further, an “interaction summary” may generally comprise a summarized/condensed version of a set of interaction data (e.g., text transcript, tabular clickstream data) across one or more communication channels. In certain embodiments, the “interaction summary” may reference a user's intent/objective, as represented by the user interaction data. For example, an interaction summary may indicate that a user intends to receive additional information about their increased premium or that the purpose of the actions represented by the user interaction is for the user to cancel/begin a service subscription.

As referenced herein, an “interaction description taxonomy” may generally reference a structured classification system created by compiling phrases from clustered interaction summaries that share a common theme or intent. This taxonomy serves as a comprehensive representation of the overarching themes or intents present in interactions across various communication channels with a particular system. An interaction description taxonomy may be associated with one or more interaction summaries (e.g., associated with a cluster of interaction summaries formed based on similarity values of embeddings of such summaries), which may have a corresponding label (referenced herein as a “cluster label” or a “cluster heading”) that generally summarizes the common theme or intent of the interaction summaries within the cluster. For example, questions such as “What are the coverage limits for prescription medications?” and “How do I get prior authorization for a prescription drug?” might be included as part of an interaction description taxonomy for a cluster with the cluster heading “Understanding Prescription Drug Coverage in the Insurance Formulary.” These extracted phrases/questions may be compiled into a generic description taxonomy that categorizes the common themes or intents identified in the user interactions and may be linked with a hierarchical taxonomy based on the cluster header (e.g., L1, L2, . . . , LN, where N is any integer) to create specific “interaction labels” to classify the user interactions.

Many typical techniques that utilize machine learning models (e.g., LLMs) struggle to classify user interactions accurately and efficiently. For example, supervised machine learning approaches generally require vast amounts of labelled training data to achieve accurate results. Once trained, these models still fail to adequately analyze new interactions, and often require additional training/updating to account for any such interactions that were not included in the original training data, creating a highly redundant and inefficient process. Unsupervised machine learning models benefit from not requiring such extensive labelled training data sets and training/re-training but are also generally unable to accurately classify new and/or nuanced interactions that the models have not previously encountered, resulting in inaccurate and unreliable/inconsistent outputs.

Further, typical systems utilizing machine learning models generally fail to provide interaction labels that are generalizable across multiple communication channels. Different communication channels (e.g., calls, chats, emails, website interactions) may inherently possess unique features and contexts, such that machine learning models trained on data from one channel may not effectively capture the nuances and specificities of interactions from another channel, leading to channel-specific models that lack generalizability. Each communication channel may generate data in different formats (e.g., audio recordings for calls, text for chats and emails, clickstream data for website interactions), and typical models may require separate preprocessing pipelines for each data type, making it challenging to develop a unified approach that works seamlessly across all channels. Without standardizing inputs, models may rely on features or patterns specific to the data format or channel, hindering their ability to generalize labels across channels. For example, a model trained on text data may not effectively classify interactions based on clickstream data without converting it into a comparable format.

Many of these typical approaches solely leverage an LLM (or the like, e.g., BERT models, GPT models) to generate interaction labels. As an example, a typical approach utilizing an LLM may involve inputting an entire user interaction (e.g., entire text transcript of a chat session) into the LLM and prompting the LLM to generate an interaction label that classifies the user interaction. However, relying on such models in this manner often results in inconsistent labeling of similar interactions, as the model's output can frequently vary depending on, e.g., subtle differences in language or context of the user interaction. Thus, this inconsistency creates a computationally intensive and inefficient interaction label generation process, especially when dealing with large volumes of user interactions. Generating numerous labels to describe similar interactions also places a substantial burden on memory resources of these typical systems to store a wider variety of generated labels than is necessary.

These models also suffer from generating plausible but incorrect/irrelevant outputs, termed “hallucinations”, which can cause such typical approaches to misclassify user interactions. For example, LLMs may overgeneralize patterns learned during training (e.g., fine-tuning), causing the LLM to assign a broad or common interaction label that does not accurately capture the specific nuances or details of a user's interaction. Additionally, or alternatively, the LLMs may generate labels that are influenced by the limitations or biases of its training dataset, particularly when the training data does not include sufficient examples of similar user interactions or it is biased towards certain types of user interactions. These LLMs may also misinterpret the context or intent behind certain phrases or keywords in the user interaction (e.g., text transcript of the chat session) resulting from the model's inability to fully understand the subtleties of human language or the specific context in which words are used and may generate an interaction label that does not accurately reflect the user's actual intent or the content of the conversation.

By contrast, the present techniques overcome these challenges faced by typical systems through a standardized classification architecture and schema that generates accurate, generalizable interaction labels without performing significantly redundant computing processes and/or otherwise occupying substantial processing/memory resources. The present techniques utilize generative machine-learned models (e.g., an LLM) in combination with a standardized interaction classification schema to leverage the advantages of such generative models without suffering from the disadvantages described herein. For example, the present techniques utilize a generative machine-learned model to generate an interaction summary of a user interaction with a device associated with a communication channel. The present techniques determine an interaction label that most closely corresponds to the summary based on similarities between feature vectors of this interaction summary and interaction description taxonomies of the classification schema.

This computer-implemented process leverages the generative machine-learned model's advantages while avoiding much of the inaccuracy and/or hallucination concerns previously described by utilizing a standardized interaction classification schema to evaluate the generative machine-learned model output. The generative machine-learned model's ability to understand and condense complex natural language data (e.g., interaction data) into a concise interaction summary reduces the volume of data that needs further processing, thereby decreasing the processing load on the computer or computing device. Generating and comparing feature vector representations of the interaction summary and the interaction description taxonomies to determine the interaction label is a highly accurate and granular process that preserves much of the relevant features of both objects (e.g., summary and description taxonomy) while constraining the output interaction label to conform to the standardized interaction classification schema. In this manner, the present techniques substantially reduce the impact of generative machine-learned model hallucinations (and correspondingly increase the output accuracy) by enforcing the output interaction label to conform to an interaction label included as part of the standardized schema.

Additionally, this standardized interaction classification schema reduces/eliminates the processing time required to train/re-train typical models by enabling the present techniques to reliably analyze/interpret new interactions. As an example, the present techniques may receive a user interaction representing a new user intent. The present techniques may input the user interaction into the generative machine-learned model for summarization and convert the interaction summary into a feature vector by an encoder (e.g., a sentence transformer). The present techniques may then compare this feature vector with interaction description taxonomy feature vectors to determine a taxonomy that is most semantically similar to the user interaction representing the new user intent and may output an interaction label from the standardized interaction classification schema that best represents the new user intent. In certain embodiments, the present techniques may also update the interaction description taxonomy to include phrases/words and/or other features from the user interaction that are representative of the interaction label and have not been encountered before. The present techniques may thereby continually update the schema while consuming substantially fewer processing resources and/or memory resources than typical techniques, as storing new phrases/words into a description taxonomy is significantly less processor/memory intensive than training/re-training a machine learning model.

In certain embodiments, the present techniques improve the generalizability of the interaction labels by normalizing the received interaction data to generate standardized interaction summaries. As mentioned, interaction data received from different communication channels may include different data types, some of which are not suitable for input into a generative machine-learned model, such as an LLM. Typical techniques sidestep this issue by creating individual models for different communication channels, but this is highly inefficient at least because it requires substantial redundant processing efforts. The present techniques preprocess and/or otherwise convert/normalize the received interaction data into a format that is suitable for input into a generative machine-learned model, enabling a single processing pipeline for all communication channels. As an example, the present techniques may receive interaction data comprising clickstream data of a user's interaction on a website. The present techniques may convert this clickstream data into a condensed, tabular format based on information gain and fill rate values associated with the interaction data, to create a clickstream dataset that is (1) highly relevant and representative of the user's interaction on the website and (2) suitable for efficient analysis by a generative machine-learned model. Similar conversions may be performed for interaction data corresponding to any communication channel, such that the present techniques generate standardized interaction summaries (and ultimately, interaction labels) that are independent of the communication channel associated with the user interaction. This generalizability enables cross-communication channel analysis, which typical techniques are generally incapable of providing.

The techniques of the present disclosure thus improve the functionality of a computing device (e.g., a hosting server such as a central server) at least by summarizing and classifying data in a particular way to enhance the accuracy and reliability provided by the machine-learned model and/or the computing device. The machine-learned model and standardized interaction classification schema, executing on the computing device, generate interaction summaries and corresponding feature vectors and determine semantically similar interaction description taxonomies/interaction labels to create generalizable and adaptable associations with user intents/objectives that were not created as part of conventional techniques. That is, the present disclosure describes improvements in the functioning of the computer itself because the computing device more accurately analyzes/classifies data as a direct result of the machine-learned model and standardized interaction classification schema. This is an improvement over other techniques at least because existing systems typically lack a reliable and/or generalizable framework and/or are otherwise unable to classify data with the accuracy, reliability, and generalizability resulting from the machine-learned model and standardized interaction classification schema.

Still further, the present disclosure includes specific features other than what is well-understood, routine, conventional activity in the field, or adding unconventional steps that demonstrate, in various embodiments, particular useful applications, e.g., generating, by a generative machine-learned model and based at least in part on the interaction data, an interaction summary that summarizes the user interaction; generating, by an encoder and based at least in part on the interaction summary, a feature vector; determining, by the one or more processors, a set of semantic similarity values based at least in part on the feature vector and one or more feature vectors generated by the encoder based at least in part on interaction description taxonomies of a standardized interaction classification schema, wherein a first interaction description taxonomy comprises a set of interaction labels; and/or determining, by the one or more processors based on the set of semantic similarity values, an interaction label of the standardized interaction classification schema, among others.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art. Moreover, while described herein primarily in the health care context, the techniques described herein may be readily applied in any suitable field for any suitable purpose.

### Example Computing System

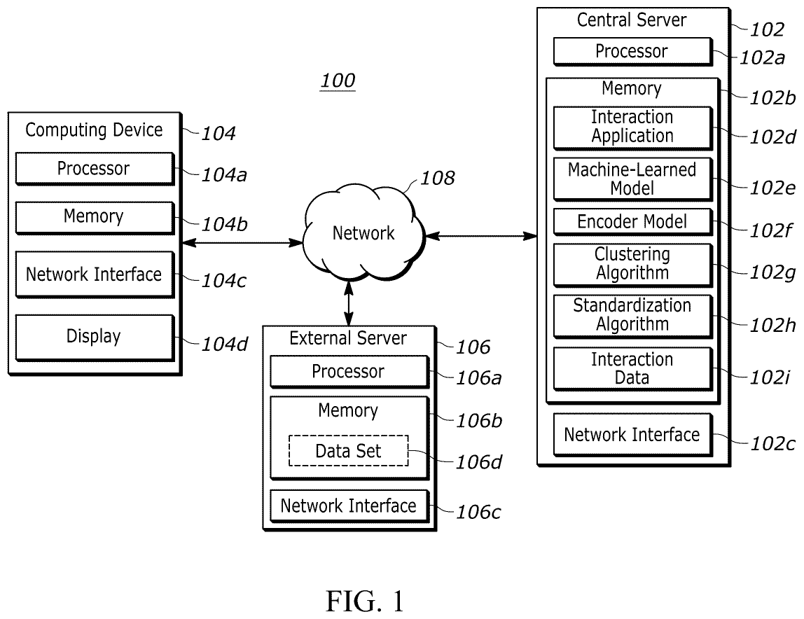

FIG. 1 depicts an example computing system 100 in which various embodiments of the present disclosure may be implemented. Depending on the embodiment, the example computing system 100 may generate interaction summaries and feature vectors of interaction data, determine interaction labels, cluster data (e.g., interaction summaries), standardize data, identify similarity values associated with interaction description taxonomies, and/or any related values or combinations thereof. Of course, it should be appreciated that, while the various components of the example computing system 100 (e.g., central server 102, computing device 104, external server 106) are illustrated in FIG. 1 as single components, the example computing system 100 may include multiple (e.g., dozens, hundreds, thousands) of computing devices 104 and external servers 106 that are simultaneously connected to the network 108 at any given time.

Generally, the example computing system 100 includes a central server 102, a computing device 104, and an external server 106. Each of the central server 102, the computing device 104, and the external server 106 may communicate with the other devices (e.g., transmit data, instructions, etc.) across the network 108. As an example, the central server 102 and/or the external server 106 may belong to a healthcare provider or hospital and the computing device 104 may belong to a patient of the healthcare provider or hospital. In this example, the patient using the computing device 104 may transmit data (e.g., interaction data including text data, voice data, and/or clickstream data) to the central server 102, and the server 102 may execute an interaction application 102d to generate data objects indicating interaction label(s) based on the transmitted data. The central server 102 may additionally or alternatively make the data object accessible to the patient via the computing device 104, so the patient may review the data object to review the generated interaction label, provide additional inputs concerning the interaction labels (e.g., confirming/denying the intent indicated by the interaction label), and/or any other suitable actions or combinations thereof.

More specifically, the central server 102 may include one or more processors 102a, a memory 102b, and a networking interface 102c. The memory 102b may store executable instructions that are configured to, when executed by the one or more processors 102a, cause the one or more processors 102a to analyze data (e.g., data set 106d) received at the central server 102 and output various values (e.g., data objects indicating interaction labels). The interaction application 102d, the machine-learned model 102e, the encoder model 102f, the clustering algorithm 102g, the standardization algorithm 102 h, and/or the interaction data 102 i may all include such executable instructions, as well as other data. The memory 102b may additionally or alternatively store additional data and/or databases. It should be appreciated that the central server 102 can include one or multiple computing devices that are co-located or distributed.

The central server 102 may receive interaction data from the computing device 104 connected to the server 102 through a network 108 and process the interaction data in accordance with one or more sets of instructions stored in a memory 102b to output any of the values described herein. The central server 102 may execute the interaction application 102d, which in turn, may access and apply the machine-learned model 102e, the encoder model 102f, the clustering algorithm 102g, the standardization algorithm 102h, and/or the interaction data 102i to the received interaction data. The received interaction data may generally include at least a subset of the information/data comprising a user interaction associated with one or more communication channels, such as via a phone call, IVR, text chat, and/or via a website. This interaction data may capture the details of the interaction, including the content of the communication, the user's actions, and the context in which the interaction occurs. Interaction data may take various forms depending on the communication channel, such as voice data from phone calls, text data from chats or emails, and clickstream data from website visits.

The interaction application 102d may preprocess, normalize, and/or otherwise adjust the interaction data received at the central server 102 and/or instruct the machine-learned model 102e to generate standardized interaction summaries using the standardization algorithm 102h. This application 102d may then input this preprocessed data, e.g., into the machine-learned model 102e to generate standardized interaction summaries.

In certain embodiments, the standardization algorithm 102h may include preprocessing interaction data from different channels. For example, the algorithm 102h may include preprocessing text-based interactions such as call transcripts, chats, IVRs, and emails by extracting relevant textual content, and preprocessing interaction data for website visits represented as clickstream data by analyzing the log file to select relevant features based on information gain and/or fill rate. Information gain generally helps identify features that provide the most information about user intent, while fill rate may indicate the completeness of data for each feature to ensure that the selected features from the interaction data are consistently present across the data. Additionally, or alternatively, the algorithm 102h may preprocess the clickstream data by utilizing any suitable metric(s), such as entropy, mutual information, a chi-squared test, a correlation coefficient, variance threshold, principal component analysis (PCA), and/or any other suitable metrics or combinations thereof.

The standardization algorithm 102h may include generating a normalized/preprocessed input (e.g., for input into the machine-learned model 102e) that includes the identified features. For text-based interactions (e.g., call transcripts, chats, IVRs, and emails), the application 102d may normalize the text by formatting the text in a consistent manner. As an example, the algorithm 102h may include and/or reference predefined formatting rules that include standardizing date and time formats to a uniform style (e.g., “YYYY-MM-DD HH:MM:SS”), normalizing abbreviations and acronyms (e.g., converting “ASAP” to “as soon as possible”), unifying the presentation of numerical data (e.g., ensuring consistent use of decimal places), applying consistent capitalization rules for titles, headings, and key terms, and/or structuring the text into clearly defined sections or paragraphs based on the content (e.g., separating questions from answers in a chat transcript).

For clickstream data, the algorithm 102h may convert the data into a tabular format by organizing the identified features based on their relevance and/or otherwise ensuring that the data is structured in a text-like manner that the machine-learned model 102e can process as an input. Thus, the standardization algorithm 102h may ensure that the interaction data, regardless of its original format or communication channel, is transformed/converted into a normalized format suitable for analysis by the LLM.

As an example, the user interaction may comprise sensor/input data associated with actions performed during a website visit (e.g., captured in clickstream data), and the user may visit the website to search for information associated with a particular medication. The interaction application 102d may apply the standardization algorithm 102h to the clickstream data to identify features such as “Page Section,” “Page Description,” and “Date_time” as having high information gain and fill rate values. The application 102d may generate a normalized input that organizes these features into a structured format, such that the user's website visit searching for the medication information may be standardized as “Pharmacy, Drug search, Enter drug name, 2021-11-02T12:31:43.000Z.” The machine-learned model 102e may process this standardized input to generate an interaction summary, such as “User inquiring about medication coverage.”

In certain embodiments, the interaction application 102d may execute the standardization algorithm 102h to instruct/prompt and/or otherwise cause the machine-learned model 102e to generate standardized interaction summaries. The algorithm 102h may include generating a prompt for input into an LLM (e.g., 102e) with the normalized interaction data and/or any other suitable context. For example, the prompt may be configured to guide the LLM to generate a standardized interaction summary by indicating that the LLM should generate an interaction summary that “reflects a standardized understanding of the user's intent”, regardless of the specific communication channel represented by the user interaction. Accordingly, the LLM may receive the interaction data (e.g., normalized interaction data) and the prompt/context generated as a result of the standardization algorithm 102h and may generate a standardized interaction summary that captures the essence of the user's intent in a standardized format (e.g., that is communication channel agnostic). This ensures that similar or identical intents, regardless of the source communication channel, may result in similar or identical interaction summaries. For instance, an inquiry about a bill increase, whether coming from a call transcript or website clickstream data, may result in an interaction summary like “User inquiring about reasons for billing increase.”

The interaction application 102d may create a standardized interaction classification schema using the clustering algorithm 102g to generate accurate/relevant interaction labels used to classify the interaction data. The interaction application 102d may execute the clustering algorithm 102g to cluster interaction summaries into clusters based on their semantic similarities to one another and these clusters may generally correspond to the schema, such that a particular cluster may correspond to one or more interaction labels and interaction description taxonomies. When a new set of interaction data is analyzed by the interaction application 102d, the application 102d may associate a feature vector of the new set of interaction data with a feature vector of an interaction description taxonomy (e.g., via semantic similarity) included as part of a cluster header of a cluster and may ultimately determine a corresponding interaction label based on the similar interaction description taxonomy feature vector.

More specifically, the clustering algorithm 102g may include instructions to cluster interaction summaries generated by the machine-learned model 102e based on feature vector representations of these interaction summaries generated by the encoder model 102f. Generally, the feature vector generation process may involve a machine-learned model (e.g., the encoder model 102f) identifying/extracting features or attributes from the input data, such as by identifying significant words or phrases (e.g., “vaccination”, “provider”, “flu”) within the interaction summary. The machine-learned model may then convert these features/attributes into n-dimensional numerical vectors or tensors that indicate a location in the n-dimensional embedding space, where n may be any integer representing, e.g., hundreds, thousands of dimensions. For example, the encoder model 102f may be a sentence transformer configured to convert sentences (e.g., interaction summaries) or short paragraphs into dense vector representations. The model 102f may thereby leverage the transformer architecture to capture the contextual and semantic meaning of the interaction summaries, producing feature vectors that encapsulate the semantic content of the interaction summaries in a numerical format that is suitable for computational analysis (e.g., semantic similarity analysis). Additionally, or alternatively, the encoder model 102f may be or include Bidirectional Encoder Representations from Transformers (BERT) models, a Generative Pre-Trained Transformer (GPT) model, XLNet, and/or other models or combinations thereof.

The application 102 d may execute the clustering algorithm 102g determine semantic similarity values of the feature vectors relative to one another and may then cluster the interaction summaries into clusters based on these semantic similarities. The clustering algorithm 102g may utilize one or more similarity metrics based on distance(s) (e.g., cosine distance, L1 distance, Euclidean distance, Hamming distance, Chebyshev distance) between the feature vectors to determine how similar any two feature vectors are in the vector space, and the algorithm 102g may cluster feature vectors (and their corresponding interaction summaries) with high similarity values relative to one another (e.g., feature vectors that are close to each other in the vector space) into the same cluster, indicating the interaction summaries share common themes or intents. For example, the clustering algorithm 102g may comprise topic modeling through an LLM, a density-based clustering method (e.g., density-based spatial clustering of applications with noise (DBSCAN)), distribution-based clustering (e.g., expectation-maximization model(s)), centroid-based clustering (e.g., k-means, k-medoids), a neural network implementing PCA (e.g., neural PCA), and/or the like. In certain embodiments, the clustering algorithm 102g may be included as part of the machine-learned model 102e, for example, where the machine-learned model 102e is an LLM configured to perform topic modeling, as described herein.

For up to each cluster, the clustering algorithm 102g may generate a cluster header that may generally represent a common theme or topic shared by the interaction summaries within the cluster, and thus may serve as a label summarizing the overarching intent of the interactions in the cluster (e.g., “Product Returns and Warranty claims”). The cluster header may be, e.g., an average feature vector that best represents the semantic content of the cluster, such that the cluster header effectively summarizes the common semantic characteristics of the grouped summaries. The clustering algorithm 102g may refine the cluster headers, e.g., by receiving inputs from external entities and/or other data sources and may generate interaction labels to create a hierarchical structure that categorizes the intents/purposes for user interactions associated with a particular cluster. In certain embodiments, the clustering performed by the clustering algorithm 102g may be iterative, with the algorithm 102g adjusting the grouping of interaction summaries and adjusting cluster headers based on predefined criteria or optimization goals, such as minimizing intra-cluster variance while maximizing inter-cluster variance. This refinement may continue until a stable clustering solution is achieved, where reassigning interaction summaries to different clusters may not significantly improve the clustering quality.

The clustering algorithm 102g may further cause the application 102d to create a generic description taxonomy for up to each cluster by compiling phrases from the clustered interaction summaries of a cluster. These phrases may be or include terms or expressions that frequently appear in the interaction summaries and/or are representative of the cluster's overarching theme or intent, as indicated by the cluster header (e.g., “return policy” and “warranty period” phrases being associated with the “Product Returns and Warranty claims” cluster header). The algorithm 102g may cause the application 102d to extract such phrases by using frequency analysis, term importance metrics, natural language processing techniques, and/or any other suitable techniques or combinations thereof. This generic description taxonomy may be flexible, such that the taxonomy reflects common themes (e.g., intents) that are applicable across different communication channels, and the application 102d may iteratively update the taxonomy over time as new phrases or intents are encountered that are relevant to a cluster's theme, ensuring that the taxonomy remains current and reflective of evolving user interactions.

The clustering algorithm 102g may further cause the application 102d to match these generic taxonomies with specific, hierarchical taxonomies that may be derived from the cluster header to generate interaction labels. These specific taxonomies may generally be structured hierarchically, with Level 1 (L1) labels representing broad categories of interactions and Level 2 (L2) labels providing more granular details about the reasons for the interactions. It should be appreciated that the specific taxonomies and/or the corresponding interaction labels described herein may include any suitable number of hierarchical levels (e.g., L1, L2, . . . , LN, where N is any integer). Further, the interaction application 102d may store the interaction data, the interaction summaries, the feature vectors, the generic taxonomies, the specific taxonomies, and/or the interaction labels in a storage location (e.g., interaction data 102i).

The algorithm 102g may cause the application 102d to perform a semantic mapping/matching between the generic taxonomies and the specific taxonomies to identify the best/optimal matches between the generic and specific taxonomies based on their respective semantic similarities. In certain embodiments, the algorithm 102g may cause the application 102d to utilize the encoder model 102f and generate feature vector representations of the generic taxonomies and the specific taxonomies to perform the semantic similarity analysis. The algorithm 102g may cause the application 102d to create the interaction labels based on which pairs of specific taxonomies and generic taxonomies have the highest similarity scores and/or which pairs have similarity scores that satisfy a threshold value.

For example, suppose the clustering algorithm 102g causes the application 102d to create a generic taxonomy with a cluster header “Product Returns and Warranty claims” and phrases “return policy” and “warranty period” from clustering interaction summaries related to returns and warranty inquiries. The clustering algorithm 102g may cause the application 102d to match this generic taxonomy with a specific taxonomy that includes the L1 label “Customer Service Inquiries” and the L2 labels “Product Returns” and “Warranty claims.” The application 102d may determine that the phrases within the generic taxonomy, such as “return policy” and “warranty period,” are semantically similar to the descriptions associated with these specific L1 and L2 taxonomies. As a result, the clustering algorithm 102g may cause the interaction application 102d to generate the interaction labels “Customer Service Inquiries-Product Returns” and “Customer Service Inquiries-Warranty claims” for interactions classified under the generic taxonomy “Product Returns and Warranty claims.”

With the standardized interaction classification schema, the interaction application 102d may utilize the machine-learned model 102e, the encoder model 102f, and/or the interaction data 102i to classify interaction data received, e.g., from the computing device 104. As an example, the computing device 104 may be a smartphone a user utilizes to conduct a phone call with a human agent, and the computing device 104 may capture/transmit voice data to the central server 102. The central server 102 may process the voice data, for example, by converting the voice data to text using speech-to-text technology and may input the text version of the interaction data into the machine-learned model 102e to generate an interaction summary of the user's phone call. This interaction summary may generally represent the user's intent/purpose for conducting the phone call. The application 102d may utilize the encoder model 102f to generate a feature vector representation of the interaction summary and may compare the interaction summary feature vector with feature vector representations of interaction description taxonomies (e.g., generic and/or specific taxonomies) associated with one or more clusters to determine similarity values of the respective feature vectors. Based on these similarity values, the application 102d may determine an interaction label that is most closely associated with the interaction summary (e.g., most closely represents the intent indicated by the interaction summary) of the user's phone call and generate a data object indicating the interaction label.

Using these interaction labels, the interaction application 102d may further output a response to the user and/or generate communication channel recommendations associated with adjusting a feature of the communication channel (e.g., training agents, updating FAQ sections of websites, adjusting IVR prompts). The application 102d may generate the communication channel recommendations if the application s102d determines that the interaction label is associated with interactions of users across the communication channel at a frequency that satisfies a frequency threshold, and the recommendation may be configured to reduce/increase the frequency of user interactions being associated with the interaction label and/or otherwise adjust a feature/aspect of the communication channel in response to the frequency threshold being satisfied. This frequency threshold may be set to enable the application 102d to determine when a particular type of user interaction becomes unusually common, indicating a potential issue and/or area for improvement.

For example, the application 102d may determine that the interaction label “L1 “Billing Inquiry” and L2—“Premium Increase” is assigned to a significantly high number of interactions within a short period, which may indicate a systemic issue or a recent change causing confusion among customers. In response, the application 102d may generate recommendations aimed at addressing the root causes of the increase in such interactions, such as updating IVR system prompts to provide immediate answers to premium increase questions, creating detailed FAQ sections on a website and mobile app specifically addressing common questions about premium increases, implementing targeted notifications or messages that preemptively inform users about why premiums might increase (e.g., directly addressing the concerns that lead to L2 interactions), and/or adjusting the script or training for call center agents to better equip them to handle inquiries about premium increases.

The application 102d may also track and/or otherwise record these recommendations (e.g., in interaction data 102i) for subsequent analysis. For example, the application 102d may compile the recommendations and/or other data from user interactions into a report for display to one or more users (e.g., system administrators) with access to the central server 102 (e.g., via an application dashboard). Moreover, the application 102d may utilize these interaction labels, responses, and/or recommendations to impact the responses provided to users as part of live communications and/or determine higher level data patterns associated with one or more components of the systems described herein.

As an example, the application 102d may analyze interaction data associated with a user making multiple calls within a specified time range. The application 102d may analyze interaction labels and/or content (e.g., interaction summaries) associated with the two calls to correlate the consecutive calls from the same user and thereby determine if the second call is a follow-up to the first call. The application 102d may also efficiently pinpoint the reason for the follow-up call based on the interaction labels associated with the first call. For instance, if the first call was labeled under the interaction label “L1—Technical Support, L2—Router Issue” and the second call, made shortly after, also relates to technical support for the same issue, the application 102d may identify that the user's problem was not resolved in the first interaction, providing the application 102d with insight into the user's pain point and reason for dissatisfaction top generate a more targeted response. The application 102d may output the identical interaction label for the second call and may take direct action to address the user's concern, such as escalating the issue to a more specialized technical support team, offering additional troubleshooting steps, and/or providing compensation if the issue cannot be resolved immediately. The application 102d may also generate one or more recommendations for improving the call center operations based on these repeat calls, such as recommended training for customer service representatives on handling common issues more effectively, updating internal knowledge bases with information on resolving specific problems, and/or refining the application 102d (and/or algorithms/models included/executed therein) to better identify and address repeat calls.

As another example, the application 102d may monitor interactions handled by chat and call bots (e.g., IVR) across various communication channels (e.g., text-based, voice based) to improve the bot design flows and conversation verbiage for better containment. The application 102d may assign interaction labels to communications (e.g., represented by user interaction data) that begin with a bot but are transferred to a human agent, such as “L1—Product Return Process, Ls—Shipping Labels”, to understand why the bot was unable to resolve the inquiry independently. the application identifies common issues and bottlenecks in the bot's handling of “Product Return Process” and “Shipping Labels” inquiries. For instance, the application 102d may determine that users frequently ask for more detailed instructions on how to print shipping labels, which the bot fails to provide adequately, leading to transfers and/or that the bot's explanations are generally unclear or incomplete. Using this data, the application 102d may generate recommendations to improve the bot's conversation flows and verbiage, such as by expanding the bot's script to include step-by-step instructions for printing shipping labels, introducing interactive elements, such as clickable links or buttons, that directly lead users to the shipping label section of the website, and/or enhancing the bot's understanding of related queries, ensuring it can recognize and respond to a wider range of expressions concerning product returns and shipping labels. The application 102d may also continue to track user interactions that are assigned to this interaction label to determine the effectiveness of any implemented changes, such as determining that the interaction label is less frequently assigned to new user interactions, which may reflect an increase in containment rates for inquiries related to “Product Return Process” and “Shipping Labels.”

As yet another example, the application 102d may utilize interaction labels to track user interactions with the goal of identifying beneficial actions by advocates during communications represented by such user interactions, particularly for users included as part of an advocacy program (e.g., an Employee and Individual (E&I) Advocacy Program). As communications occur within, e.g., a call center, the application 102d may assign/classify the user interactions representing such communications with interaction labels based on the user's intent, such as “L1—Account Access Issues,” “L1—Billing Inquiry,” or “L1—Policy Coverage Questions.” The application 102d may correlate these user interactions and may use the L1 reasons as a primary filter to reduce the vast number of user interactions to those most relevant for further analysis. The application 102d may then determine those user interactions specifically related to users enrolled in an E&I advocacy program by cross-referencing user information and the interaction labels to pinpoint user interactions that may involve E&I program users and their unique concerns or inquiries. The application 102d may analyze the actions taken by advocates (e.g., call center agents) during these communications to determine patterns and strategies that may lead to positive outcomes, such as quick resolution of issues, high user satisfaction, and/or cost-saving measures that benefit both the user and the call center. The application 102d may identify specific beneficial advocate actions that do not compromise the quality of service, such as efficiently guiding users through self-service options, providing clear and concise information that prevents follow-up calls, and/or identifying and addressing the root cause of an issue in a single interaction. The application 102d may leverage this analysis to determine recommendations to further improve the call center operations, such as enhancing advocate training programs and/or update standard operating procedures to ensure advocates are equipped to replicate these successful strategies in future interactions with E&I advocacy program users.

Is still another example, the application 102d may retrieve and analyze user interactions related to specific topics, such as “UCard” or “Covid-19,” by filtering and determining similar user interactions based on the interaction labels and context. The application 102d may receive an input from a user (e.g., system administrator) indicating a specific phrase related to a topic of interest, for example, “UCard activation issues” or “Covid-19 policy changes,” which may serve as an initial filter for the semantic search along with interaction labels. The application 102d may use interaction labels, such as “L1-Account Services, L2 UCard Activation” or “L1—Health Concerns, L2—Covid-19” to narrow down the search to user interactions that may be semantically related to the entered phrase and may be specifically categorized under relevant interaction labels, which may ensure that the search results are highly relevant to the topic of interest and enable a focused analysis of how users discuss and inquire about specific issues. The application 102d may then retrieve a subset of user interactions that match the criteria and may output these user interactions (and/or data associated therewith) to enable users to analyze the content of these user interactions along with the application 102d. Thus, the application 102d may determine common concerns, questions, and/or misconceptions users may have about the topic, such as challenges with activating a UCard or seeking information about Covid-19 policies, and the application 102d may identify trends in user sentiment/intents and/or highlight areas where additional communication or clarification may be needed. The application 102d may also determine recommendations to inform organizational strategies and/or communication plans. For instance, if the application 102d determines that user interactions commonly indicate user confusion about how to activate a UCard, the recommendation may suggest development of targeted communication materials to address this issue, update FAQs, create informative content, and/or adjust policies in response to the user needs.

As yet another example, the application 102d may enhance voice of the customer/user (VOC) analysis within a chat-based communication channel based on the interaction labels of user interactions associated with the chat-based communication channel to, e.g., understand any underlying issues leading to user grievances. As users engage in chat-based communications, the application 102d may assign an interaction label to the user interactions based on the user's intent and the content of the conversation, such as “L1—Technical Support, L2—Software Issue, L3—Software Installation Issue” if the customer is experiencing problems installing software. The application 102d may specifically identify user interactions that indicate/include grievances or dissatisfaction from the user, such as through directly statements by the user and/or as inferred from the context and sentiment of the conversation. The application 102d may analyze the user interactions to understand the underlying issues leading to the grievances, which may be based on the interaction labels associated the user interactions, where the L1 label provides a broad category of the issue (e.g., “Technical Support”), the L2 label represents a more granular description of the issue (e.g., “Software Issue”), and the L3 label may represent a highly granular description of the issue (e.g., “Software Installation Issue”). The application 102d may then categorize the identified issues into specific buckets for improvement, where the buckets may correspond to a common theme or type of issue, such as “Installation Process Clarity” or “Software Compatibility Information,” to thereby group similar grievances together and make it easier for the application 102d and/or other systems described herein to address them systematically. For up to each bucket of issues, the application 102d may generate recommendations for flow and conversational improvements in chat-based communications, such as enhancing the chatbot's script to provide clearer instructions for software installation, introducing interactive elements (e.g., tutorial videos or step-by-step guides) within the chat interface, and/or training customer service representatives on addressing specific technical issues more effectively.

Additionally, or alternatively, the techniques described herein may be applied during an active/live communication to generate interaction labels, and thereby provide recommendations for adjusting features of the communication channel in real-time, and/or otherwise provide feedback regarding the currently occurring communication. For example, during a live communication the interaction application 102d may determine a response for the user based on the interaction label. The response may include information addressing the user's query/intent that may be retrieved by the application 102d based on the interaction label, such as by following pre-defined file paths and/or other links that may be stored and/or otherwise associated with the interaction label (e.g., stored in the interaction data 102i). The response may additionally, or alternatively, include displaying an interactive message requesting input from the user (e.g., with clickable buttons for providing user input/feedback), providing a link to an associated resource (e.g., on a source website), initiating a chatbot interaction with the user (e.g., connecting the user to a trained machine-learned chatbot to continue the communication), providing contact information (e.g., a phone number, email address) for routing the user to a human agent, and/or any other suitable information or combinations thereof. In these embodiments, the interaction application 102d may generate the data object to indicate the interaction label and the response.

In certain embodiments, the interaction application 102d may utilize the data objects, interaction labels indicated therein, the interaction data, the interaction summary, and/or other data (e.g., outcomes of the interactions) to update the standardized interaction classification schema. The application 102d may analyze new interaction data, interaction summaries, and corresponding feature vectors to determine patterns, emerging themes, and/or changes in user behavior or preferences across different communication channels. More specifically, the application 102d may determine new phrases or terms that appear in the interaction summaries but are not currently represented in the interaction description taxonomy of a cluster. Such new phrases may arise from evolving user needs, changes in products or services, shifts in industry terminology, or the like. Regardless, the application 102d may incorporate these newly identified phrases into the interaction description taxonomy by determining the relevance and significance of each new phrase in the context of existing cluster headers and determining where the new phrases best fit within the hierarchical structure of the clusters/taxonomy.

The application 102d may add these new phrases to the interaction description taxonomy of a cluster, ensuring that the taxonomy remains comprehensive and accurately reflects the relevant range of user interactions. For example, the application 102d may re-categorize existing phrases, introduce new cluster headers, adjust the hierarchy of interaction labels to better capture the nuances of user intent, and/or otherwise modify aspects of the taxonomy/cluster based on the new phrases. Moreover, the application 102d may iteratively update the interaction description taxonomy, interaction labels, cluster headers, and/or the clusters based on new interaction data to ensure that the taxonomies/clusters evolve in response to changes in user behavior and interaction trends.

As an example, suppose the interaction application 102d determine an emerging trend in user interactions related to “virtual healthcare consultations.” Based on clustering and refinement, the interaction application 102d may create a new cluster header “Virtual Healthcare Inquiries” and may generate the interaction description taxonomy to include phrases “Healthcare Services” and “Virtual Consultations”. The application 102d may match these phrases from the interaction description taxonomy with a specific taxonomy and update the schema to include this new cluster/taxonomy of interactions.

As another example, the interaction application 102d may determine an increase in user inquiries related to “telehealth services” across various communication channels. The application 102d may extract new phrases related to telehealth from generated interaction summaries, such as “virtual doctor appointments” and “online medical consultations.” The application 102d may incorporate these phrases into the interaction description taxonomy under a new or existing cluster header related to healthcare services. Thus, the application 102d may refine the taxonomy by including these updates, ensuring that the classification schema accurately captures the growing interest in telehealth services among users.

More generally, the computing device 104 may be or include any one or more devices that is associated with (e.g., owned and/or operated by) one or more entities that may provide data (e.g., interaction data) that is transmitted to and/or is otherwise accessible by the central server 102 and/or the external server 106 through the network 108. In certain embodiments, the user interaction data transmitted to and/or otherwise accessible by the central server 102 and/or the external server 106 may be or include a set of voice data, text data, and/or clickstream data associated with a communication facilitated by the computing device 104 to be evaluated by the central server 102 and/or the external server 106. In some embodiments, the computing device 104 is a server or collection of servers hosting the interaction data or a portion thereof, e.g., since the interaction data may comprise interaction data of multiple users received from different computing devices. However, in certain embodiments, the computing device 104 is a personal computing device of that entity/user, such as a smartphone, a tablet, smart glasses, or any other suitable device or combination of devices (e.g., a smart watch plus a smartphone) with wireless communication capability. In the embodiment of FIG. 1, the computing device 104 includes a processor 104a, a memory 104b, a networking interface 104c, and a display 104d.

The computing device 104 may be communicatively coupled to the central server 102 and/or the external server 106. For example, the computing device 104, the central server 102, and/or the external server 106 may communicate via USB, Bluetooth, Wi-Fi Direct, Near Field Communication (NFC), a private or public network (e.g., via an Internet protocol, such as IPv4, via a virtual private network (VPN)), etc. For example, the central server 102 may transmit a data object indicating an interaction label, an interaction summary, a generated feature vector, an outcome of the interaction, an update to the classification schema and/or a feature of a communication channel, and/or any other values, responses, or combinations thereof to the computing device 104 via the networking interface 102c, which the computing device 104 may receive via the networking interface 104c.

The external server 106 may be or include computing servers and/or combinations of multiple servers storing data that may be accessed/retrieved by the central server 102 and/or the computing device 104. In certain embodiments, the external server 106 receives data from the central server 102 and/or the computing device 104 and retrieves/accesses information stored in memory 106b for transmission back to the central server 102 and/or the computing device 104. The external server 106 may include a processor 106a, a memory 106b, and a networking interface 106c. It should be appreciated that the external server 106 can include one or multiple computing devices that are co-located or distributed.

Further, in certain embodiments, the external server 106 includes a data set 106d including data from one or both of the computing device 104 and/or the central server 102. In one such example, the external server 106 is a server located in and/or otherwise associated with a hospital or other healthcare provider, and the data set 106d includes electronic health records, hospital policies/regulations, benefits/policy information, and/or the like in memory 106b. As another example, the external server 106 serves as a database for some/all of the interaction data 102i. In some embodiments, the example computing system 100 does not include the external server 106.

Each of the processors 102a, 104a, 106a may include any suitable number of processors and/or processor types. For example, the processors 102a, 104a, 106a may each include one or more CPUs and one or more graphics processing units (GPUs). Generally, each of the processors 102a, 104a, 106a may be configured to execute software instructions stored in each of the corresponding memories 102b, 104b, 106b. The memories 102b, 104b, 106b may each include one or more persistent memories (e.g., a hard drive and/or solid-state memory) and may store one or more applications, modules, and/or models, such as the interaction application 102d.

The networking interface 102c may enable the central server 102 to communicate with the computing device 104, the external server 106, and/or any other suitable devices or combinations thereof. More specifically, the networking interface 102c may enable the central server 102 to communicate with each component of the example computing system 100 across the network 108 through their respective networking interfaces 104c, 106c. The networking interfaces 102c, 104c, 106c may support one or more of the communication/network protocols implemented by the network 108. The networking interface 102c may enable the central server 102 to communicate with the various components of the example computing system 100 via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc.

Moreover, the network 108 may be a single communication network, or may include multiple communication networks of one or more types (e.g., one or more wired and/or PANs or LANs, and/or one or more WANs such as the Internet). In some embodiments, the network 108 includes multiple, entirely distinct networks (e.g., one or more networks for communications between central server 102 and computing device 104, and a separate, Bluetooth or wireless LAN (WLAN) network for communications between central server 102 and computing device 104, and so on).

It will be understood that the above disclosure is one example and does not necessarily describe every possible embodiment. As such, it will be further understood that alternate embodiments may include fewer, alternate, and/or additional steps or elements.

### Example User Interaction Classification Computer-Implemented Processes

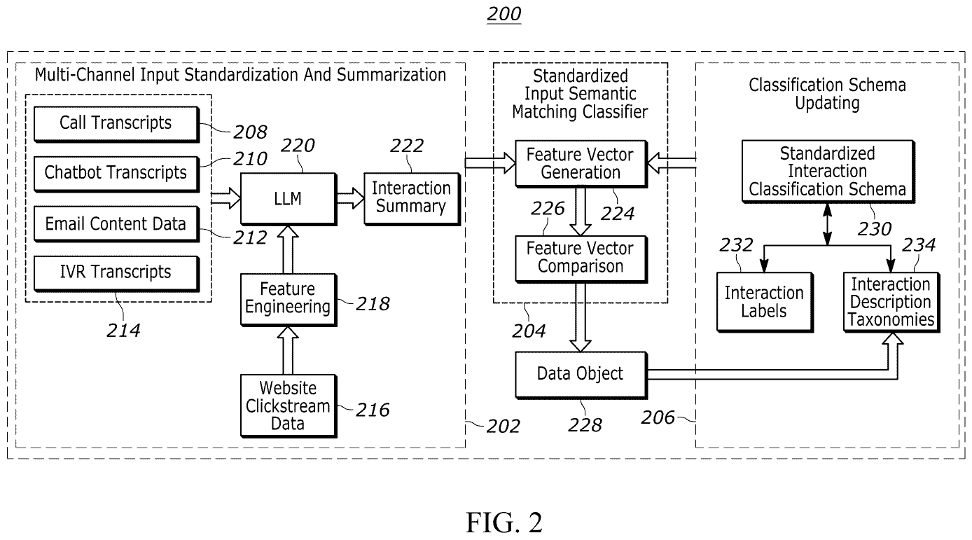

FIG. 2 depicts an example interaction classification computer-implemented process 200, in accordance with various embodiments described herein. The example interaction classification computer-implemented process 200 broadly illustrates the computer-implemented process 200 as a sequence of actions, although the computer-implemented process 200 may be executed in series, in parallel, or in any other order, and may be performed by central server 102 (e.g., processor 102a and/or other components of central server 102) of FIG. 1, for example, to receive interaction data (e.g., call transcripts 208, chatbot transcripts 210, email content data 212, IVR transcripts 214, website clickstream data 216) as input and output data objects 228. The example interaction classification computer-implemented process 200 illustrated in FIG. 2 is for the purposes of discussion only, and additional/alternative interaction classification sequences may additionally or alternatively be utilized.

The example interaction classification computer-implemented process 200 may include a multi-channel (e.g., communication channels) standardization and summarization block 202, a standardized input semantic matching classifier block 204, and a classification schema updating block 206. The multi-channel standardization and summarization block 202 may include a set of interaction data that comprises call transcripts 208, chatbot transcripts 210, email content data 212, IVR transcripts 214, and website clickstream data 216. The call transcripts 208, the chatbot transcripts 210, the email content data 212, and the IVR transcripts 214 may be text-based data, such that the data may be input directly into the LLM 220 to generate interaction summaries to represent the user interactions comprising the data 208, 210, 212, and/or 214. For example, the data 208, 210, 212, and/or 214 may be extracted and/or otherwise input into a prompt that includes instructions for the LLM 220 to generate an interaction summary 222 based on any of the data 208, 210, 212, and/or 214.

The block 202 may include preprocessing and/or otherwise adjusting the website clickstream data 216 prior to inputting the data 216 into the LLM 220. Given the vast amount of data that may be included in the website clickstream data 216, which may record/represent most or every action a user takes and may be spread across numerous tables with hundreds (e.g., over 500) of fields, the block 202 may include selecting relevant features from the data 216 that accurately represent user interactions. For example, preprocessing the data 216 may include selecting features based on criteria such as information gain and fill rate, which help identify features that provide significant insight into user behavior and/or are most frequently populated. This preprocessing may thereby significantly reduce the dimensionality of the data, making it more manageable (e.g., less demanding on computing resources) and focused on the most informative aspects of user interactions.

With these relevant features, block 202 may further include applying feature engineering 218 to further refine the website clickstream data 216. This may include creating new features and/or modifying existing features to better capture the nuances of user behavior by, for example, summarizing sequences of actions into higher-level behaviors and/or calculating the time spent in various parts of the website. The feature engineering 218 may further comprise applying heuristic feature weighting to the data 216 to prioritize the features based on their perceived importance in representing user interactions. This feature weighting may generally include assigning weights to different features based on heuristic rules or algorithms, which may reflect the relative significance of each feature in understanding user behavior. For example, actions that are more indicative of user intent, such as completing a purchase, may be assigned higher weights than more common actions like page views. The feature engineering 218 may further include organizing the weighted features into a tabular format which is suitable for input into the LLM 220. The LLM 220 may receive this input tabular data, with the engineered features and heuristic weights, to generate the interaction summary 222.

The standardized input semantic matching classifier block 204 includes performing feature vector generation at block 224 on the interaction summary 222 and taxonomies from the standardized interaction classification schema 230. Performing the feature vector generation 224 may include applying an encoder model (e.g., encoder model 102f) to the interaction summary 222 and/or taxonomies (e.g., interaction description taxonomies 234) to generate feature vector representations of the interaction summary 222 and/or taxonomies, as described herein. In certain embodiments, block 224 may include generating feature vector representations of taxonomies of the standardized interaction classification schema 230 asynchronously from the interaction summary 222, such as when the taxonomies are first created/generated and/or updated. These asynchronously generated feature vectors may then be stored in a storage location associated with the cluster (e.g., interaction data 102i), and block 224 may include accessing the storage location to retrieve one or more of the feature vector representations of the taxonomies when generating a feature vector representation of the interaction summary 222.

Block 204 may further include comparing the feature vector representations at block 226. In particular, block 226 may include determining semantic similarity values of the feature vector of the interaction summary 222 with respect to one or more feature vectors representing the interaction description taxonomies (e.g., 234) of the standardized interaction classification schema 230. Block 226 may further include determining which interaction description taxonomy has the highest semantic similarity value relative to the feature vector of the interaction summary 222, as described herein, to determine which interaction label most likely represents the intent/purpose of the user's interaction. Additionally, or alternatively, block 226 may include determining which interaction description taxonomies have a semantic similarity value that satisfies a similarity threshold value to determine which interaction label represents the intent/purpose of the user's interaction. Based on these semantic similarity values, block 204 may include determining a data object 228 that includes and/or otherwise indicates the interaction label corresponding to the interaction description taxonomy feature vector that has the highest semantic similarity value relative to the interaction summary 222 feature vector.

The data object 228 may also be used to update the interaction description taxonomies 234 of the standardized interaction classification schema 230. Namely, the classification schema updating block 206 may include the standardized interaction classification schema 230, which comprises interaction labels 232 and corresponding interaction description taxonomies 234. Block 206 may include receiving the data object 228 and/or the data included/indicated therein (e.g., an interaction label indication), and utilizing the data object 228 to update the interaction description taxonomies 234. In certain embodiments, these updates to the interaction description taxonomies 234 may also facilitate updates to the interaction labels 232.

For example, call transcripts 208 may include a communication where a user inquires about an increase in their premium amount. The LLM 220 may receive this call transcript, analyzes the dialogue for key points, and generate an interaction summary that states “caller wants to find out why his premium has increased so much,” thereby capturing the user's primary intent. At block 224, the interaction summary may be transformed into a feature vector by, e.g., identifying and encoding significant phrases, such as “premium increase,” “not notified,” and/or “customer concern,” into a numerical format. Block 226 may include comparing this feature vector against those of existing interaction description taxonomies 234 within the standardized interaction classification schema 230, which may include categories like “Billing Inquiries,” “Notification Issues,” and “Service Changes.” Further, block 226 may include determining semantic similarity values between the feature vector of the interaction summary 222 and/or of phrases included therein and those of the taxonomies 234 to determine that the “Billing Inquiries” taxonomy feature vector has the highest semantic similarity value relative to the interaction summary 222 feature vector, as it most closely matches the content and context of the interaction summary 222. Further, block 206 may include updating the corresponding interaction description taxonomies 234 to include any phrases included as part of the interaction summary (e.g., “premium increase”, “customer concern”) that meet or exceed the similarity threshold associated with the interaction description taxonomies 234.

Block 204 may further include generating, based on the identified taxonomy 234, a data object 228 that includes/indicates an interaction label 232 with multiple, hierarchical tiers, such as “Billing Inquiries >Premium Changes >Notification Issues.” This structured interaction label 232 may classify the interaction summary 222 (and by proxy, the user interaction) within a broader framework of customer service inquiries. Block 206 may include updating the “Billing Inquiries” taxonomy 234 by incorporating new phrases from the interaction summary 222, such as “unexpected premium increase” and “lack of notification”, into the taxonomy 234. This addition ensures that the taxonomy 234 remains relevant and comprehensive.

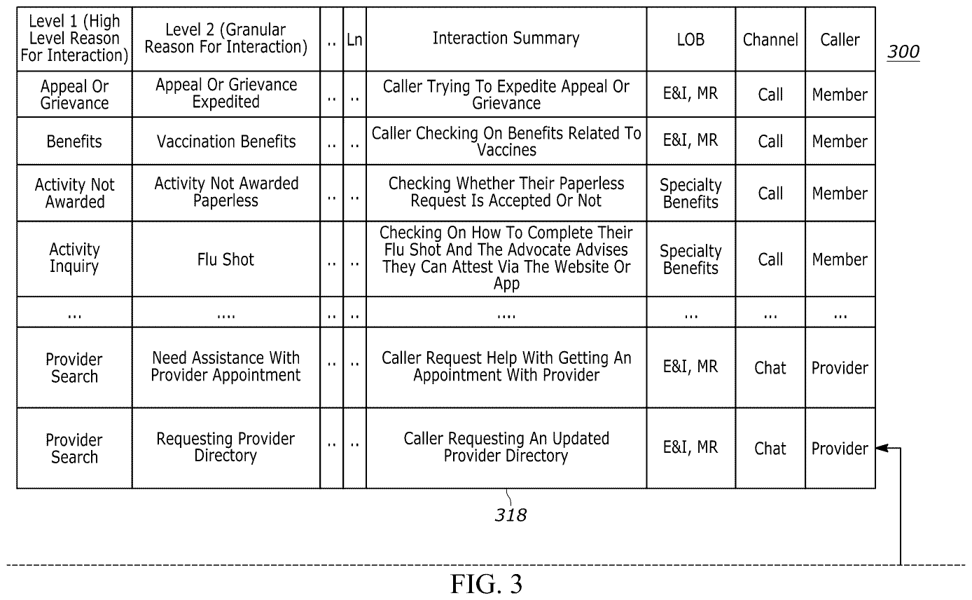

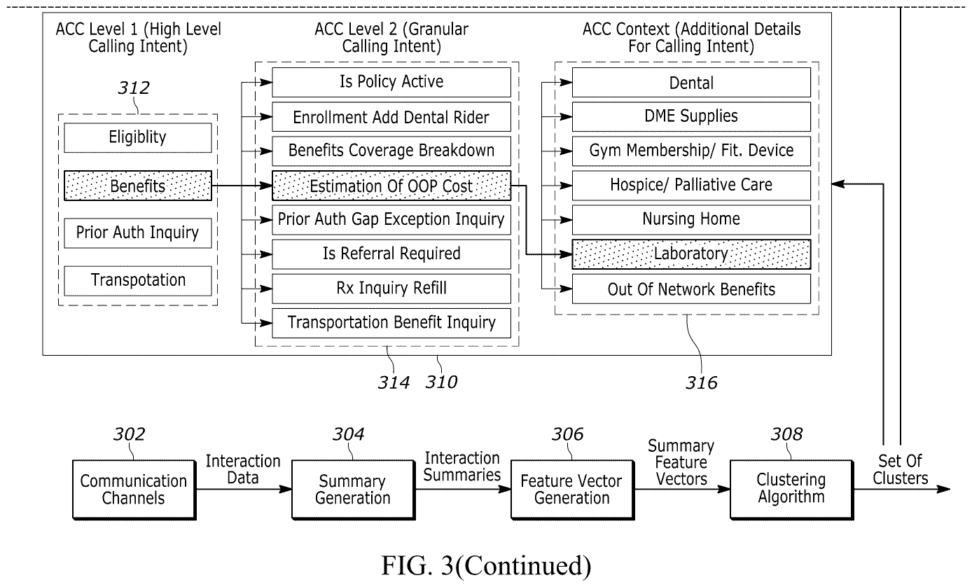

FIG. 3 depicts an example standardized interaction classification schema creation computer-implemented process 300, in accordance with various embodiments described herein. The example standardized interaction classification schema creation computer-implemented process 300 broadly illustrates the computer-implemented process 300 as a sequence of actions, although the computer-implemented process 300 may be executed in series, in parallel, or in any other order, and may be performed by central server 102 (e.g., processor 102a and/or other components of central server 102) of FIG. 1, for example, to receive interaction data (e.g., call transcripts 208, chatbot transcripts 210, email content data 212, IVR transcripts 214, website clickstream data 216) as input and output sets of clusters. The example standardized interaction classification schema creation computer-implemented process 300 illustrated in FIG. 3 is for the purposes of discussion only, and additional/alternative interaction classification schema creation sequences may additionally or alternatively be utilized.

The example standardized interaction classification schema creation computer-implemented process 300 may include one or more communication channels 302 (e.g., phone call, website, IVR, chatbot), across which, a user may conduct/perform a communication. These communications across the communication channels 302 generate user interaction data (e.g., text-based transcripts, clickstream data, voice data) which may be analyzed at block 304 to generate interaction summaries for the user interactions. Block 304 may include an LLM receiving the interaction data as part of a prompt that instructs the LLM to generate summaries (e.g., one to two sentences each) of the user interactions by preserving relevant information from the interaction data.

The example computer-implemented process 300 may further include generating feature vectors of the interaction summaries (block 306). As previously mentioned, generating the feature vectors may include inputting the interaction summaries into an encoder model (e.g., encoder model 102f) which may generate feature vectors that numerically represent the interaction summaries. The computer-implemented process 300 may further include clustering the interaction summaries into a set of clusters based on, for example, distances of the feature vectors from one another in the vector space (block 308).

These sets of clusters may generally represent a standardized interaction classification schema, such that a user interaction may be included in a cluster of the set of clusters because the intent/purpose of the user in performing the actions represented by the user interaction is similar to (e.g., semantically similar to) the intents/purposes of users that performed other actions represented by user interactions included in the cluster. The clusters may have corresponding cluster headers/interaction description taxonomies and interaction labels that classify the user interactions included as part of the clusters.

For example, the set of clusters may correspond to the schema 318 and the interaction labels 310, which may be included as part of the schema 318. The schema 318 generally includes interaction labels (e.g., Level 1, Level 2, Level N), interaction summaries, communication channel indications, as well as line of business and caller type indications. The interaction labels 310 further illustrates the granularity and hierarchical dependencies of the first level labels 312, the second level labels 314, and the third level labels 316. The first level labels 312 may generally represent a high-level intent of the user interaction, the second level labels 314 may generally represent a more granular intent of the user interaction than the first level labels 312, and the third level labels 316 may generally provide additional context/details regarding the user interaction. For example, the highlighted interaction labels include a first level label 312 of “Benefits”, a second level label 314 of “Estimation of OOP Cost”, and a third level label 316 of “Laboratory”, indicating that a user interaction likely features a user requesting information regarding the out-of-pocket cost associated with a laboratory test under their current benefits plan.

In certain embodiments, the clustering algorithm 308 may indicate generating groupings/clusters of interaction summaries based on the proximity of the feature vector of a particular interaction summary to individual feature vectors and/or clusters of feature vectors. For example, the clustering algorithm 308 may determine which feature vector of a standardized interaction summary is most proximate (e.g., via similarity values) to the feature vector of a particular interaction summary. Additionally, or alternatively, the clustering algorithm 308 may determine which cluster of interaction summaries is most proximate (e.g., via an average feature vector of the cluster) to the feature vector of the particular interaction summary.

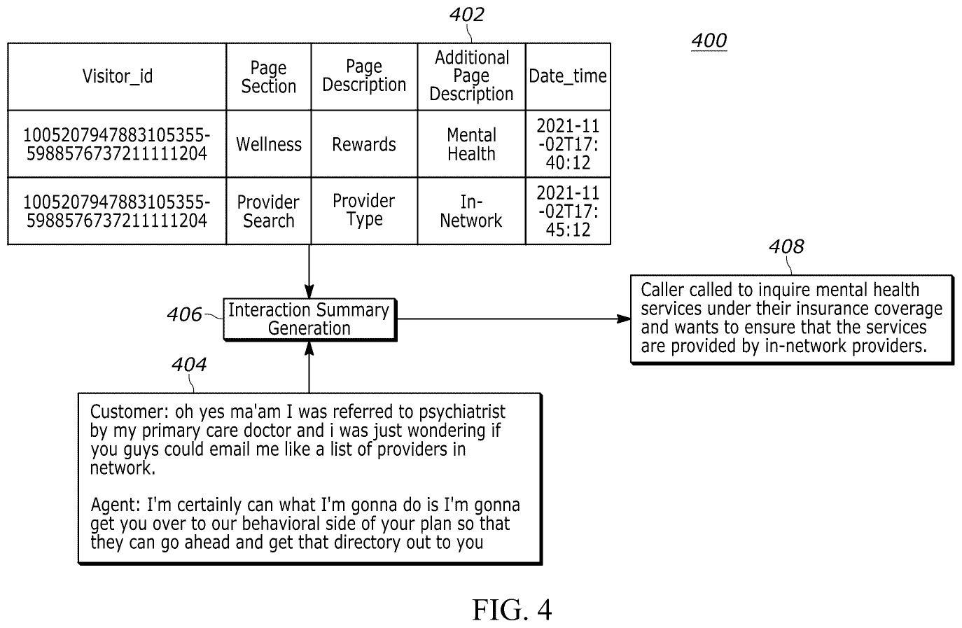

FIG. 4 depicts an example interaction summary generation computer-implemented process 400 across different communication channels, in accordance with various embodiments described herein. The example interaction summary generation computer-implemented process 400 broadly illustrates the computer-implemented process 400 as a sequence of actions, although the computer-implemented process 400 may be executed in series, in parallel, or in any other order, and may be performed by central server 102 (e.g., processor 102a and/or other components of central server 102) of FIG. 1, for example, to receive standardized interaction data 402, 404 as input and output an interaction summary 408. The example interaction summary generation computer-implemented process 400 illustrated in FIG. 4 is for the purposes of discussion only, and additional/alternative interaction summary generation sequences may additionally or alternatively be utilized.

The example interaction summary generation computer-implemented process 400 may include a first set of interaction data 402 (e.g., clickstream data) and a second set of interaction data 404 (e.g., call transcript). The first set of interaction data 402 and/or the second set of interaction data 404 may be preprocessed prior to input into the LLM for summarization, as part of block 406. For example, the first set of interaction data 402 may originally (e.g., prior to the formatted version of the data 402 illustrated in FIG. 4) be raw clickstream data with potentially hundreds of data entries representing individual actions performed by a user (e.g., represented by the visitor_id of data 402) during their website visit. After preprocessing, the clickstream data may be condensed into the tabular format illustrated by the first set of interaction data 402 with columns representing a visitor_id values, page section values, page description values, additional page description values, and date_time values, up to each of which may be included in the first set of interaction data 402 based on information gain and/or fill rate values.

In particular, in the computer-implemented process 400 of FIG. 4, both the first set of interaction data 402 and the second set of interaction data 404 may represent a similar communication (e.g., requesting information about in-network mental health service providers) across different communication channels. The first set of interaction data 402 may represent the communication as a website visit (e.g., searching for a provider on a website), and the second set of interaction data 404 may represent a similar communication as a telephone call transcript (e.g., speaking with a human agent/IVR to search for a provider). The computer-implemented process 400 may further include generating interaction summaries of the first and second sets of interaction data 402, 402 (block 406) by, e.g., inputting the sets of interaction data 402, 404 into an LLM with a prompt instructing the LLM to summarize the sets of interaction data 402, 404. The prompt may include instructions that cause the LLM to generate the standardized interaction summary 408.

The standardized interaction summary 408 may include a brief, general summarization of the interaction data included in the input interaction data and may be the interaction summary output by the LLM at block 406 for either or both sets of interaction data 402, 404. For example, suppose the first set of interaction data 402 is received and processed at block 406 at a first time, and LLM of block 406 outputs the standardized interaction summary 408. At a second time that is different from the first time, block 406 may receive the second set of interaction data 404 and may again output the standardized interaction summary 408. In this manner, the actions performed at block 406 to generate the interaction summaries may generate standardized interaction summaries (e.g., 408) that accurately indicate the intent/purpose represented by the data comprising the user interaction regardless of the communication channel across which the communication represented by the user interaction occurred. As illustrated in FIG. 4, the standardized interaction summary 408 may state “Caller called to inquire mental health services under their insurance coverage and wants to ensure that the services are provided by in-network providers.” This single sentence summary accurately captures the intent/purpose of the communications represented by both the first and the second set of interaction data 402, 404, and thereby enables the techniques described herein to provide cross-communication channel insights without sacrificing the granularity encapsulated by the sets of interaction data 402, 404.

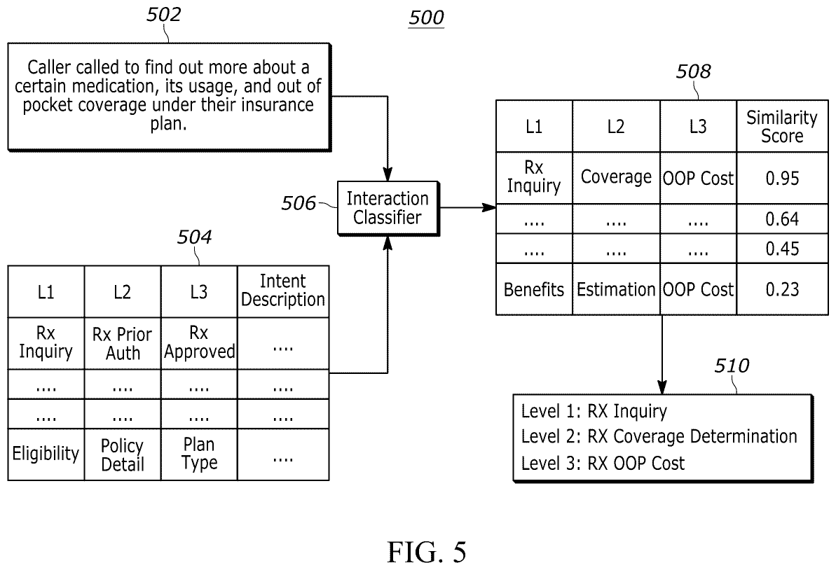

FIG. 5 depicts an example interaction summary classification computer-implemented process 500 using a standardized interaction classification schema, in accordance with various embodiments described herein. The example interaction summary classification computer-implemented process 500 broadly illustrates the computer-implemented process 500 as a sequence of actions, although the computer-implemented process 500 may be executed in series, in parallel, or in any other order, and may be performed by central server 102 (e.g., processor 102a and/or other components of central server 102) of FIG. 1, for example, to receive an interaction summary 502 and interaction description taxonomies from a schema 504 as input and output an interaction label 510 for inclusion/indication in a data object. The example interaction summary classification computer-implemented process 500 illustrated in FIG. 5 is for the purposes of discussion only, and additional/alternative interaction summary classification sequences may additionally or alternatively be utilized.

The example interaction summary classification computer-implemented process 500 may include a standardized interaction summary 502 and a standardized interaction classification schema 504 that includes interaction labels and interaction descriptions (e.g., cluster headers and/or other phrases from the interaction description taxonomy). The computer-implemented process 500 may include inputting both the summary 502 and elements of the schema 504 into an interaction classifier (block 506) to determine semantic similarity scores/values 508 and corresponding interaction labels 510. The interaction classifier of block 506 may include an encoder model (e.g., model 102f) that is configured to generate feature vectors or other embeddings of the standardized interaction summary 502 and interaction descriptions of the standardized interaction classification schema 504. Block 506 may further include determining semantic similarity values between the feature vector of the summary 502 and feature vectors of interaction descriptions from the schema 504 to determine which interaction description (and corresponding interaction labels) is most semantically similar to the summary 502. The interaction description with the highest and/or otherwise satisfactory (e.g., determined via thresholding) semantic similarity score/value relative to the summary 502 may most accurately represent the intent/purpose indicated by the data comprising the user interaction, such that the interaction labels corresponding to the interaction description may apply to the user interaction.

For example, the standardized interaction summary 502 states that a “caller called to find out more about a certain medication, its usage, and out of pocket coverage under their insurance plan.” The schema 504 may include multiple interaction labels, such as “L1—Rx Inquiry, L2—Rx Prior Auth, L3—Rx Approved”, and corresponding interaction descriptions that summarize these interaction labels in the form of a unified phrase/sentence (e.g., “User requesting information about prior authorization for a prescription medication that was approved”). The computer-implemented process 500 may include generating feature vectors of the standardized interaction summary 502 (e.g., via a sentence transformer) and generating and/or retrieving/accessing feature vectors representing the interaction descriptions of the schema 504, and comparing the feature vectors (e.g., pairwise) to determine the semantic similarity scores/values 508. The scores/values 508 include a “0.95” semantic similarity score for a first interaction description with a corresponding interaction label 510 “L1—Rx Inquiry, L2—Coverage, and L 3—OOP Cost, and a set of smaller scores (e.g., 0.64, 0.45, 0.23) for other interaction descriptions that are part of the schema 504. Thus, the interaction classifier of block 506 and/or other suitable components described herein may determine that the first interaction description has the highest semantic similarity score/value relative to the summary 502 and may most accurately represent the intent/purpose indicated by the data comprising the user interaction, such that the user interaction may be classified and/or otherwise associated with the interaction label 510.

### Example Computer-Implemented Methods

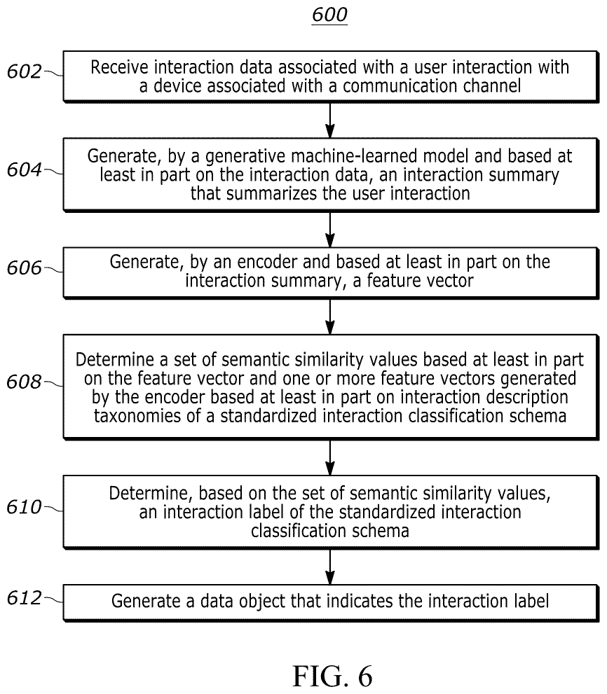

FIG. 6 depicts a flow diagram representing an example computer-implemented method 600, in accordance with various embodiments described herein. The method 600 may be implemented by one or more processors of the example computing system 100, such as the processor 102a of central server 102 (e.g., by interaction application 102d), for example.

The method 600 may include receiving interaction data associated with a user interaction with a device associated with a communication channel (block 602). The method 600 may further include generating, by a generative machine-learned model and based at least in part on the interaction data, an interaction summary that summarizes the user interaction (block 604). The method 600 may further include generating, by an encoder and based at least in part on the interaction summary, a feature vector (block 606).

The method 600 may further include determining a set of semantic similarity values based at least in part on the feature vector and one or more feature vectors generated by the encoder based at least in part on interaction description taxonomies of a standardized interaction classification schema (block 608). A first interaction description taxonomy may comprise a set of interaction labels. The method 600 may further include determining, based on the set of semantic similarity values, an interaction label of the standardized interaction classification schema (block 610). The method 600 may further include generating a data object that indicates the interaction label (block 612).

In certain embodiments, the interaction summary may be a first interaction summary of a plurality of interaction summaries, and the method 600 may further include clustering, by the one or more processors executing a clustering algorithm, feature vectors corresponding to the plurality of interaction summaries into a set of clusters, the set of clusters representing the standardized interaction classification schema; determining, by the one or more processors, a cluster label for a first cluster of the set of clusters based on the interaction summaries from the plurality of interaction summaries included in the first cluster, the cluster label indicating common semantic characteristics of the interaction summaries included in the first cluster; and storing, by the one or more processors, the interaction summaries included in the first cluster and the cluster label in a storage location associated with a corresponding interaction label as an interaction description taxonomy.

In certain embodiments, the communication channel may comprise a first communication channel, and the method 600 may further include preprocessing, by the one or more processors executing a standardization algorithm, the interaction data to determine one or more features of interest based on at least one of: (i) an information gain value of the one or more features of interest or (ii) a fill rate value of the one or more features of interest; generating, by the one or more processors, a normalized input that includes the one or more features of interest; and generating, by the generative machine-learned model based at least in part on the normalized input, the interaction summary.

In certain embodiments, the normalized input may be a first normalized input, a second normalized input may be determined based at least in part on an interaction transcript associated with a second communication channel that is different from the first communication channel, and the method 600 may further include generating, by the one or more processors executing the standardization algorithm, a prompt for input to the generative machine-learned model that comprises at least: (i) a portion of the first normalized input and (ii) a portion of the second normalized input; and generating, by the generative machine-learned model based on the prompt, a standardized interaction summary.

In certain embodiments, the method 600 may further include determining, by the one or more processors, that (i) a first phrase of the interaction summary is not included in the interaction description taxonomy associated with the interaction summary and (ii) the first phrase of the interaction summary meets or exceeds a similarity threshold associated with the interaction description taxonomy; and updating, by the one or more processors, the interaction description taxonomy to include the first phrase of the interaction summary.

In certain embodiments, the method 600 may further include generating, by the encoder, an updated feature vector based at least in part on at least the first phrase; and associating the updated feature vector with the interaction label.

In certain embodiments, the interaction label may comprise a plurality of levels, and generating the data object may further include determining, by the one or more processors, a response for a user based on the interaction label, wherein the response includes at least one of: (i) displaying an interactive message requesting input from the user, (ii) providing a link to an associated resource, (iii) initiating a chatbot interaction with the user, or (iv) providing contact information for routing the user to a human agent; and generating, by the one or more processors, the data object to indicate the interaction label and the response.

In certain embodiments, the method 600 may further include determining, by the one or more processors, that the interaction label is associated with interactions of users with devices associated with the communication channel at a frequency that meets or exceeds a frequency threshold; and generating, by the one or more processors based on the frequency, a communication channel recommendation for adjusting a feature associated with the communication channel to reduce the frequency, wherein the data object indicates the interaction label and the communication channel recommendation.

In certain embodiments, the communication channel may comprise two or more of: (i) an audio-based communication channel (e.g., a telephone call with a human agent, an interactive voice response (IVR) system), (ii) a text-based communication channel (e.g., an online webchat, an email, a text message), (iii) a video-based communication channel (e.g., a videoconferencing platform, a streaming platform, a video messaging application), and/or (iv) a website.

Of course, it is to be appreciated that the actions of the method 600 may be performed any suitable number of times, and that the actions described in reference to the method 600 may be performed in any suitable order.

### EXAMPLES

Example 1. A computer-implemented method comprising: receiving, by one or more processors, interaction data associated with a user interaction with a device associated with a communication channel; generating, by a generative machine-learned model and based at least in part on the interaction data, an interaction summary that summarizes the user interaction; generating, by an encoder and based at least in part on the interaction summary, a feature vector; determining, by the one or more processors, a set of semantic similarity values based at least in part on the feature vector and one or more feature vectors generated by the encoder based at least in part on interaction description taxonomies of a standardized interaction classification schema, wherein a first interaction description taxonomy comprises a set of interaction labels; determining, by the one or more processors based on the set of semantic similarity values, an interaction label of the standardized interaction classification schema; and generating, by the one or more processors, a data object that indicates the interaction label.

Example 2. The computer-implemented method of example 1, wherein the interaction summary is a first interaction summary of a plurality of interaction summaries, and the computer-implemented method further comprises: clustering, by the one or more processors executing a clustering algorithm, feature vectors corresponding to the plurality of interaction summaries into a set of clusters, the set of clusters representing the standardized interaction classification schema; determining, by the one or more processors, a cluster label for a first cluster of the set of clusters based on the interaction summaries from the plurality of interaction summaries included in the first cluster, the cluster label indicating common semantic characteristics of the interaction summaries included in the first cluster; and storing, by the one or more processors, the interaction summaries included in the first cluster and the cluster label in a storage location associated with a corresponding interaction label as an interaction description taxonomy.

Example 3. The computer-implemented method of example 1 or 2, wherein the communication channel comprises a first communication channel, and the computer-implemented method further comprises: preprocessing, by the one or more processors executing a standardization algorithm, the interaction data to determine one or more features of interest based on at least one of: (i) an information gain value of the one or more features of interest or (ii) a fill rate value of the one or more features of interest; generating, by the one or more processors, a normalized input that includes the one or more features of interest; and generating, by the generative machine-learned model based at least in part on the normalized input, the interaction summary.

Example 4. The computer-implemented method of example 3, wherein the normalized input is a first normalized input, a second normalized input is determined based at least in part on an interaction transcript associated with a second communication channel that is different from the first communication channel, and the computer-implemented method further comprises: generating, by the one or more processors executing the standardization algorithm, a prompt for input to the generative machine-learned model that comprises at least: (i) a portion of the first normalized Input and (ii) a portion of the second normalized input; and generating, by the generative machine-learned model based on the prompt, the standardized interaction summary.

Example 5. The computer-implemented method of any of examples 1 through 4, further comprising: determining, by the one or more processors, that (i) a first phrase of the interaction summary is not included in the interaction description taxonomy associated with the interaction summary and (ii) the first phrase of the interaction summary meets or exceeds a similarity threshold associated with the interaction description taxonomy; and updating, by the one or more processors, the interaction description taxonomy to include the portion of the interaction summary.

Example 6. The computer-implemented method of example 5, further comprising: generating, by the encoder, an updated feature vector based at least in part on at least the first phrase; and associating the updated feature vector with the interaction label.

Example 7. The computer-implemented method of any of examples 1 through 6, wherein the interaction label comprises a plurality of levels, and generating the data object further comprises: determining, by the one or more processors, a response for the user based on the interaction label, wherein the response includes at least one of: (i) displaying an interactive message requesting input from the user, (ii) providing a link to an associated resource, (iii) initiating a chatbot interaction with the user, or (iv) providing contact information for routing the user to a human agent; and generating, by the one or more processors, the data object to indicate the interaction label and the response.

Example 8. The computer-implemented method of any of examples 1 through 7, wherein the computer-implemented method further comprises: determining, by the one or more processors, that the interaction label is associated with interactions of users with devices associated with the communication channel at a frequency that meets or exceeds a frequency threshold; and generating, by the one or more processors based on the frequency, a communication channel recommendation for adjusting a feature associated with the communication channel to reduce the frequency, wherein the data object indicates the interaction label and the communication channel recommendation.

Example 9. The computer-implemented method of any of examples 1 through 8, wherein the communication channel comprises two or more of: (i) an audio-based communication channel, (ii) a text-based communication channel, (iii) a video-based communication channel, or (iv) a website.

Example 10. A system comprising: one or more processors; and at least one memory storing processor-executable instructions that, when executed by the one or more processors, cause the one or more processors to perform operations comprising: receiving interaction data associated with a user interaction with a device associated with a communication channel, generating, by a generative machine-learned model and based at least in part on the interaction data, an interaction summary that summarizes the user interaction, generating, by an encoder and based at least in part on the interaction summary, a feature vector, determining a set of semantic similarity values based at least in part on the feature vector and one or more feature vectors generated by the encoder based at least in part on interaction description taxonomies of a standardized interaction classification schema, wherein a first interaction description taxonomy comprises a set of interaction labels, determining, based on the set of semantic similarity values, an interaction label of the standardized interaction classification schema, and generating a data object that indicates the interaction label.

Example 11. The system of example 10, wherein the interaction summary is a first interaction summary of a plurality of interaction summaries, and the processor-executable instructions, when executed by the one or more processors, further cause the one or more processors to perform operations comprising: clustering, by executing a clustering algorithm, feature vectors corresponding to the plurality of interaction summaries into a set of clusters, the set of clusters representing the standardized interaction classification schema; determining a cluster label for a first cluster of the set of clusters based on the interaction summaries from the plurality of interaction summaries included in the first cluster, the cluster label indicating common semantic characteristics of the interaction summaries included in the first cluster; and storing the interaction summaries included in the first cluster and the cluster label in a storage location associated with a corresponding interaction label as an interaction description taxonomy.

Example 12. The system of example 10 or 11, wherein the communication channel comprises a first communication channel, and the processor-executable instructions, when executed by the one or more processors, further cause the one or more processors to perform operations comprising: preprocessing, by executing a standardization algorithm, the interaction data to determine one or more features of interest based on at least one of: (i) an information gain value of the one or more features of interest or (ii) a fill rate value of the one or more features of interest; generating a normalized input that includes the one or more features of interest; and generating, by the generative machine-learned model based at least in part on the normalized input, the interaction summary.

Example 13. The system of example 12, wherein the normalized input is a first normalized input, a second normalized input is determined based at least in part on an interaction transcript associated with a second communication channel that is different from the first communication channel, and the processor-executable instructions, when executed by the one or more processors, further cause the one or more processors to perform operations comprising: generating, by executing the standardization algorithm, a prompt for input to the generative machine-learned model that comprises at least: (i) a portion of the first normalized input and (ii) a portion of the second normalized input; and generating, by the generative machine-learned model based at least in part on the second normalized input, the standardized interaction summary.

Example 14. The system of any of examples 10 through 13, wherein the processor-executable instructions, when executed by the one or more processors, further cause the one or more processors to perform operations comprising: determining that (i) a first phrase of the interaction summary is not included in the interaction description taxonomy corresponding to the interaction summary and (ii) the first phrase of the interaction summary meets or exceeds a similarity threshold associated with the interaction description taxonomy; and updating the interaction description taxonomy to include the portion of the interaction summary.

Example 15. The system of example 14, wherein the processor-executable instructions, when executed by the one or more processors, further cause the one or more processors to perform operations comprising: generating, by the encoder, an updated feature vector based at least in part on at least the first phrase; and associating the updated feature vector with the interaction label.

Example 16. The system of any of examples 10 through 15, wherein the interaction label comprises a plurality of levels, and the processor-executable instructions, when executed by the one or more processors, further cause the one or more processors to generate the data object by: determining a response for the user based on the interaction label, wherein the response includes at least one of: (i) displaying an interactive message requesting input from the user, (ii) providing a link to an associated resource, (iii) initiating a chatbot interaction with the user, or (iv) providing contact information for routing the user to a human agent; and generating the data object to indicate the interaction label and the response.

Example 17. The system of any of examples 10 through 16, wherein the processor-executable instructions, when executed by the one or more processors, further cause the one or more processors to perform operations comprising: determining that the interaction label is associated with interactions of users with devices associated with the communication channel at a frequency that meets or exceeds a frequency threshold; and generating, based on the frequency, a communication channel recommendation for adjusting a feature associated with the communication channel to reduce the frequency, wherein the data object indicates the interaction label and the communication channel recommendation.

Example 18. One or more non-transitory computer-readable media storing processor-executable instructions that, when executed by one or more processors, cause the one or more processors to perform operations comprising: receiving interaction data associated with a user interaction with a device associated with a communication channel; generating, by a generative machine-learned model and based at least in part on the interaction data, an interaction summary that summarizes the user interaction; generating, by an encoder and based at least in part on the interaction summary, a feature vector; determining a set of semantic similarity values based at least in part on the feature vector and one or more feature vectors generated by the encoder based at least in part on interaction description taxonomies of a standardized interaction classification schema, wherein a first interaction description taxonomy comprises a set of interaction labels; determining, based on the set of semantic similarity values, an interaction label of the standardized interaction classification schema; and generating a data object that indicates the interaction label.

Example 19. The one or more non-transitory computer-readable media of example 18, wherein the communication channel comprises a first communication channel, and the processor-executable instructions, when executed by the one or more processors, further cause the one or more processors to perform operations comprising: preprocessing, by executing a standardization algorithm, the interaction data to determine one or more features of interest based on at least one of: (i) an information gain value of the one or more features of interest or (ii) a fill rate value of the one or more features of interest; generating a normalized input that includes the one or more features of interest; and generating, by the generative machine-learned model based at least in part on the normalized input, the interaction summary.

Example 20. The one or more non-transitory computer-readable media of example 19, wherein the normalized input is a first normalized input, a second normalized input is determined based at least in part on an interaction transcript associated with a second communication channel that is different from the first communication channel, and the processor-executable instructions, when executed by the one or more processors, further cause the one or more processors to perform operations comprising: generating, by executing the standardization algorithm, a prompt for input to the generative machine-learned model that comprises at least: (i) a portion of the first normalized input and (ii) a portion of the second normalized input; and generating, by the generative machine-learned model based on the prompt, the standardized interaction summary.

Example 21. The computer-implemented method of Example 1, wherein the generative machine-learned model is fine-tuned by the one or more processors.

Example 22. The computer-implemented method of Example 1, wherein: the one or more processors are included in a first computing entity; and the generative machine-learned model is fine-tuned by one or more processors included in a second computing entity.

### Additional Considerations

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine-learned model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A computer-implemented method comprising:
receiving, by one or more processors, interaction data associated with a user interaction with a device associated with a communication channel;
generating, by a generative machine-learned model and based at least in part on the interaction data, an interaction summary that summarizes the user interaction;
generating, by an encoder and based at least in part on the interaction summary, a feature vector;
determining, by the one or more processors, a set of semantic similarity values based at least in part on the feature vector and one or more feature vectors generated by the encoder based at least in part on interaction description taxonomies of a standardized interaction classification schema, wherein a first interaction description taxonomy comprises a set of interaction labels;
determining, by the one or more processors based on the set of semantic similarity values, an interaction label of the standardized interaction classification schema; and
generating, by the one or more processors, a data object that indicates the interaction label.

2. The computer-implemented method of claim 1, wherein the interaction summary is a first interaction summary of a plurality of interaction summaries, and the computer-implemented method further comprises:
clustering, by the one or more processors executing a clustering algorithm, feature vectors corresponding to the plurality of interaction summaries into a set of clusters, the set of clusters representing the standardized interaction classification schema;
determining, by the one or more processors, a cluster label for a first cluster of the set of clusters based on the interaction summaries from the plurality of interaction summaries included in the first cluster, the cluster label indicating common semantic characteristics of the interaction summaries included in the first cluster; and
storing, by the one or more processors, the interaction summaries included in the first cluster and the cluster label in a storage location associated with a corresponding interaction label as an interaction description taxonomy.

3. The computer-implemented method of claim 1, wherein the communication channel comprises a first communication channel, and the computer-implemented method further comprises:
preprocessing, by the one or more processors executing a standardization algorithm, the interaction data to determine one or more features of interest based on at least one of: (i) an information gain value of the one or more features of interest or (ii) a fill rate value of the one or more features of interest;
generating, by the one or more processors, a normalized input that includes the one or more features of interest; and
generating, by the generative machine-learned model based at least in part on the normalized input, the interaction summary.

4. The computer-implemented method of claim 3, wherein the normalized input is a first normalized input, a second normalized input is determined based at least in part on an interaction transcript associated with a second communication channel that is different from the first communication channel, and the computer-implemented method further comprises:
generating, by the one or more processors executing the standardization algorithm, a prompt for input to the generative machine-learned model that comprises at least: (i) a portion of the first normalized input and (ii) a portion of the second normalized input; and
generating, by the generative machine-learned model based on the prompt, a standardized interaction summary.

5. The computer-implemented method of claim 1, further comprising:
determining, by the one or more processors, that (i) a first phrase of the interaction summary is not included in the interaction description taxonomy associated with the interaction summary and (ii) the first phrase of the interaction summary meets or exceeds a similarity threshold associated with the interaction description taxonomy; and
updating, by the one or more processors, the interaction description taxonomy to include the first phrase of the interaction summary.

6. The computer-implemented method of claim 5, further comprising:
generating, by the encoder, an updated feature vector based at least in part on at least the first phrase; and
associating the updated feature vector with the interaction label.

7. The computer-implemented method of claim 1, wherein the interaction label comprises a plurality of levels, and generating the data object further comprises:
determining, by the one or more processors, a response for a user based on the interaction label, wherein the response includes at least one of: (i) displaying an interactive message requesting input from the user, (ii) providing a link to an associated resource, (iii) initiating a chatbot interaction with the user, or (iv) providing contact information for routing the user to a human agent; and
generating, by the one or more processors, the data object to indicate the interaction label and the response.

8. The computer-implemented method of claim 1, wherein the computer-implemented method further comprises:
determining, by the one or more processors, that the interaction label is associated with interactions of users with devices associated with the communication channel at a frequency that meets or exceeds a frequency threshold; and
generating, by the one or more processors based on the frequency, a communication channel recommendation for adjusting a feature associated with the communication channel to reduce the frequency,
wherein the data object indicates the interaction label and the communication channel recommendation.

9. The computer-implemented method of claim 1, wherein the communication channel comprises two or more of: (i) an audio-based communication channel, (ii) a text-based communication channel, (iii) a video-based communication channel, or (iv) a website.

10. A system comprising:
one or more processors; and
at least one memory storing processor-executable instructions that, when executed by the one or more processors, cause the one or more processors to perform operations comprising:
receiving interaction data associated with a user interaction with a device associated with a communication channel,
generating, by a generative machine-learned model and based at least in part on the interaction data, an interaction summary that summarizes the user interaction,
generating, by an encoder and based at least in part on the interaction summary, a feature vector,
determining a set of semantic similarity values based at least in part on the feature vector and one or more feature vectors generated by the encoder based at least in part on interaction description taxonomies of a standardized interaction classification schema, wherein a first interaction description taxonomy comprises a set of interaction labels,
determining, based on the set of semantic similarity values, an interaction label of the standardized interaction classification schema, and
generating a data object that indicates the interaction label.

11. The system of claim 10, wherein the interaction summary is a first interaction summary of a plurality of interaction summaries, and the processor-executable instructions, when executed by the one or more processors, further cause the one or more processors to perform operations comprising:
clustering, by executing a clustering algorithm, feature vectors corresponding to the plurality of interaction summaries into a set of clusters, the set of clusters representing the standardized interaction classification schema;
determining a cluster label for a first cluster of the set of clusters based on the interaction summaries from the plurality of interaction summaries included in the first cluster, the cluster label indicating common semantic characteristics of the interaction summaries included in the first cluster; and
storing the interaction summaries included in the first cluster and the cluster label in a storage location associated with a corresponding interaction label as an interaction description taxonomy.

12. The system of claim 10, wherein the communication channel comprises a first communication channel, and the processor-executable instructions, when executed by the one or more processors, further cause the one or more processors to perform operations comprising:
preprocessing, by executing a standardization algorithm, the interaction data to determine one or more features of interest based on at least one of: (i) an information gain value of the one or more features of interest or (ii) a fill rate value of the one or more features of interest;
generating a normalized input that includes the one or more features of interest; and
generating, by the generative machine-learned model based at least in part on the normalized input, the interaction summary.

13. The system of claim 12, wherein the normalized input is a first normalized input, a second normalized input is determined based at least in part on an interaction transcript associated with a second communication channel that is different from the first communication channel, and the processor-executable instructions, when executed by the one or more processors, further cause the one or more processors to perform operations comprising:
generating, by executing the standardization algorithm, a prompt for input to the generative machine-learned model that comprises at least: (i) a portion of the first normalized input and (ii) a portion of the second normalized input; and
generating, by the generative machine-learned model based at least in part on the second normalized input, a standardized interaction summary.

14. The system of claim 10, wherein the processor-executable instructions, when executed by the one or more processors, further cause the one or more processors to perform operations comprising:
determining that (i) a first phrase of the interaction summary is not included in the interaction description taxonomy corresponding to the interaction summary and (ii) the first phrase of the interaction summary meets or exceeds a similarity threshold associated with the interaction description taxonomy; and
updating the interaction description taxonomy to include the first phrase of the interaction summary.

15. The system of claim 14, wherein the processor-executable instructions, when executed by the one or more processors, further cause the one or more processors to perform operations comprising:
generating, by the encoder, an updated feature vector based at least in part on at least the first phrase; and
associating the updated feature vector with the interaction label.

16. The system of claim 10, wherein the interaction label comprises a plurality of levels, and the processor-executable instructions, when executed by the one or more processors, further cause the one or more processors to generate the data object by:
determining a response for a user based on the interaction label, wherein the response includes at least one of: (i) displaying an interactive message requesting input from the user, (ii) providing a link to an associated resource, (iii) initiating a chatbot interaction with the user, or (iv) providing contact information for routing the user to a human agent; and
generating the data object to indicate the interaction label and the response.

17. The system of claim 10, wherein the processor-executable instructions, when executed by the one or more processors, further cause the one or more processors to perform operations comprising:
determining that the interaction label is associated with interactions of users with devices associated with the communication channel at a frequency that meets or exceeds a frequency threshold; and
generating, based on the frequency, a communication channel recommendation for adjusting a feature associated with the communication channel to reduce the frequency,
wherein the data object indicates the interaction label and the communication channel recommendation.

18. One or more non-transitory computer-readable media storing processor-executable instructions that, when executed by one or more processors, cause the one or more processors to perform operations comprising:
receiving interaction data associated with a user interaction with a device associated with a communication channel;
generating, by a generative machine-learned model and based at least in part on the interaction data, an interaction summary that summarizes the user interaction;
generating, by an encoder and based at least in part on the interaction summary, a feature vector;
determining a set of semantic similarity values based at least in part on the feature vector and one or more feature vectors generated by the encoder based at least in part on interaction description taxonomies of a standardized interaction classification schema, wherein a first interaction description taxonomy comprises a set of interaction labels;
determining, based on the set of semantic similarity values, an interaction label of the standardized interaction classification schema; and
generating a data object that indicates the interaction label.

19. The one or more non-transitory computer-readable media of claim 18, wherein the communication channel comprises a first communication channel, and the processor-executable instructions, when executed by the one or more processors, further cause the one or more processors to perform operations comprising:
preprocessing, by executing a standardization algorithm, the interaction data to determine one or more features of interest based on at least one of: (i) an information gain value of the one or more features of interest or (ii) a fill rate value of the one or more features of interest;
generating a normalized input that includes the one or more features of interest; and
generating, by the generative machine-learned model based at least in part on the normalized input, the interaction summary.

20. The one or more non-transitory computer-readable media of claim 19, wherein the normalized input is a first normalized input, a second normalized input is determined based at least in part on an interaction transcript associated with a second communication channel that is different from the first communication channel, and the processor-executable instructions, when executed by the one or more processors, further cause the one or more processors to perform operations comprising:
generating, by executing the standardization algorithm, a prompt for input to the generative machine-learned model that comprises at least: (i) a portion of the first normalized input and (ii) a portion of the second normalized input; and
generating, by the generative machine-learned model based on the prompt, a standardized interaction summary.
